(19) United States
(12) Patent Application Publication
(10) Pub. No.: US 2003/0054091 A1
(43) Pub. Date: Mar. 20, 2003

(54) Method and fixture for evaluating the quality of surface coatings

(76) Inventors: Harold Mukamal, W. Bloomfield, MI (US); David Kusuma, Canton, MI (US)

Correspondence Address: John R. Benefiel, Suite 100 B, 280 Daines Street, Birmingham, MI, 48009, US

(21) Appl. No.: 09/896,122

(22) Filed: Jun. 29, 2001

(51) Int. Cl. B05D 1/00

(52) U.S. Cl. 427/8

(57) ABSTRACT

A fixture and method for evaluating a surface coating on a specimen by determining the elongation at failure, which is carried out by conforming the specimen to a surface having a continuously and progressively varying radius of curvature to produce a range of elongations of said specimen sufficient to insure a coating failure. The radius of curvature increases in a predetermined, preferably linear relationship with the distance along the surface so that by measuring the distance to the maximum radius of curvature whereat of failure of the coating occurs, the minimum percent elongation creating failure is determined.

### BACKGROUND OF THE INVENTION

This invention concerns the quality evaluation of surface coatings and more particularly, a determination of the extent of elongation or strain required to fail the coating by cracking thereof.

Coatings are used for a wide variety of purposes on a wide variety of surfaces.

Plastic panels have heretofore been plasma coated with abrasion resistant material to allow the use of plastic such as polycarbonate in vehicle windows. It has been the practice to evaluate the quality of such coatings by bending a strip specimen about each of a series of mandrels of decreasing diameter, until failure of the coating occurs. A percent elongation at failure could be calculated from the diameter of the mandrel at which failure occurs, although such test is usually used as a simple pass-fail test. That is, the coating must withstand wrapping about of a mandrel of maximum diameter to be acceptable.

The disadvantage of this procedure is that the test is slow and does not give a precise result, as the use of only a limited number of mandrels is practical, and the exact degree of strain at failure would often be somewhere between two successive mandrels in the series.

It is the object of the present invention to provide a method and fixture for measuring strain to failure of surface coatings which produces more precise results and is accomplished much more quickly than the prior art methods and fixtures.

### SUMMARY O FTEH INVENTION

The above object and others which will become apparent upon a reading of the following specification and claims are achieved by a method including the step of conforming a strip coated specimen to be evaluated to a fixture surface which has a progressively varying radius of curvature, having a range of radii such that the coating will fail at some point along the length of the specimen.

The radius of curvature of each point along the fixture surface has a predetermined relationship with the distance along the surface so that the maximum radius of curvature causing coating failure may be determined by measuring the distance from an initial bending point to the point of failure. The minimum percent of elongation causing coating failure can be derived from the radius of curvature at that point by the application of a known mathematical formula.

The radius of curvature preferably continuously varies at a predetermined rate of change in such a way as to have a linear relationship with the circumferential distance along the fixture surface (corresponding to the specimen length) so as to make interpolations easy between known points along a plot of the radius of curvature and the distance along the circumference of the surface.

The range of radii is matched to an anticipated range of percent strain values for the particular order of thickness of the coating to be evaluated, and the rate of change of the radius of curvature is set so that the length of the specimens is accommodated.

The fixture surface contour can be generated by various methods including an iterative process and the use of commercially available CAD software to develop the complete form of the surface.

### DESCRIPTION OF THE DRAWINGS

FIG. 1 is a side elevational view of a fixture and a specimen in place, the specimen also shown in phantom in position prior to being conformed to the varying radius fixture surface.

FIG. 2 is a plot of the relationship between the circumferential distance along the fixture surface and the radius of the surface at each point.

FIG. 3 is a diagram illustrating certain geometric relationships of the fixture surface used to derive one possible form of that surface.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

The present invention was developed to evaluate anti-abrasion coatings applied to a polycarbonate substrate. Many other applications are possible, such as with paint or primer coatings on metal or plastic. The specific configuration of a fixture according to the present invention may vary with a number of factors. Examples of such factors are the length of the specimens used, the range of percentage elongations to failure anticipated, the order of thickness of the coating to be evaluated, the desired resolution of the test, as well as other practical considerations.

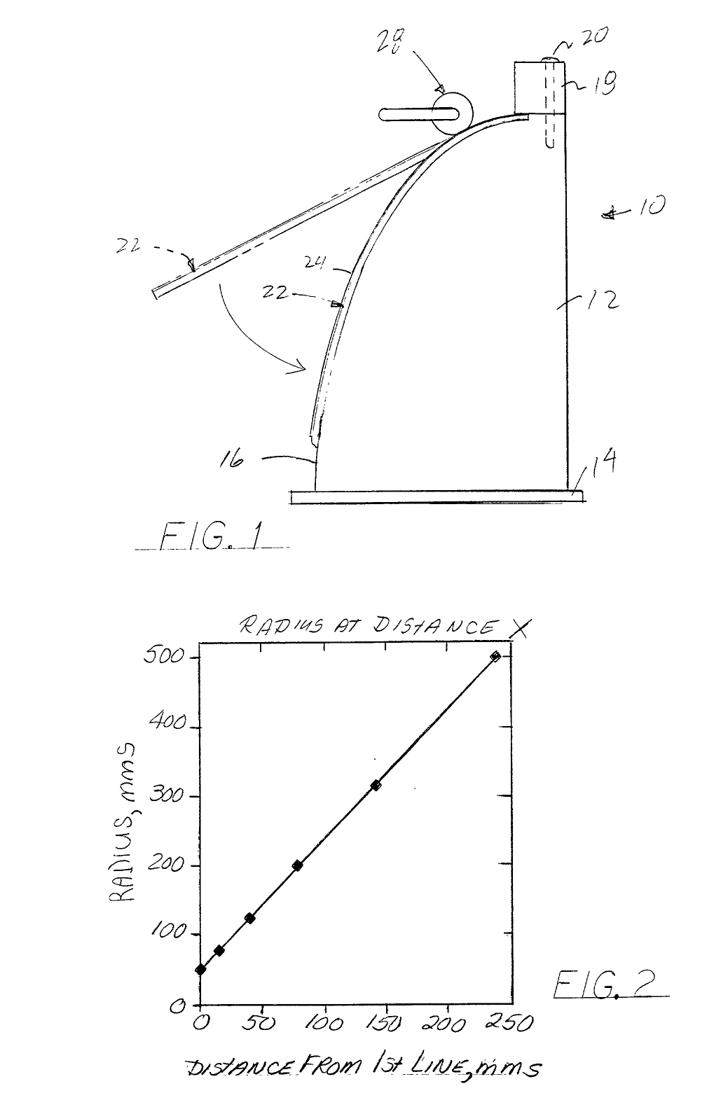

The fixture 10 shown in FIG. 1 was designed for the above described particular application, using 10 inch specimens, an elongation range to failure of 0.4 to 4% elongation, and a coating thickness on the order of 3 or 4 mm. The fixture 10 could also be designed to be suited for many other applications and test parameters.

The fixture 10 includes an upright slab-shaped fixture member 12 of a thickness accommodating the width of the specimens to be tested, i.e., typically one inch. A base 14 supports the fixture member 12 in the upright position shown. A curving contoured surface 16 extends upwardly from the base 14 to the top where a specimen clamp 18 is mounted with tightening screws 20 used to secure one end of a specimen 22. The length of the surface 16 is selected to accommodate the specimen 22, i.e., ten inches for example.

The curving fixture surface 16 is shaped to have a varying radius progressively changing at a predetermined rate, from a minimum at one end to a maximum at the other end. When the specimen 22 is pressed into conformity therewith along its length, which may be aided with a manually handled roller 28, the resulting bending of the specimen 22 causes a varying degree of strain or elongation of a coating 24 on the outer surface of the specimen 22 depending on the radius of curvature of the surface 16 at each point along the surface 16.

A line 26 is marked on the specimen 22 at the point where the radius of curvature is at minimum, and bending of the specimen 22 begins.

The failure of the coating will begin at some point along the length of the specimen 22 spaced from the large radius end of the surface 16 and continue with the decreasing radius of curvature portions of the surface 16. The distance to the point of failure is measured after the specimen 22 has been removed from the fixture 10 and flattened. That distance is conveniently measured from the mark 26.

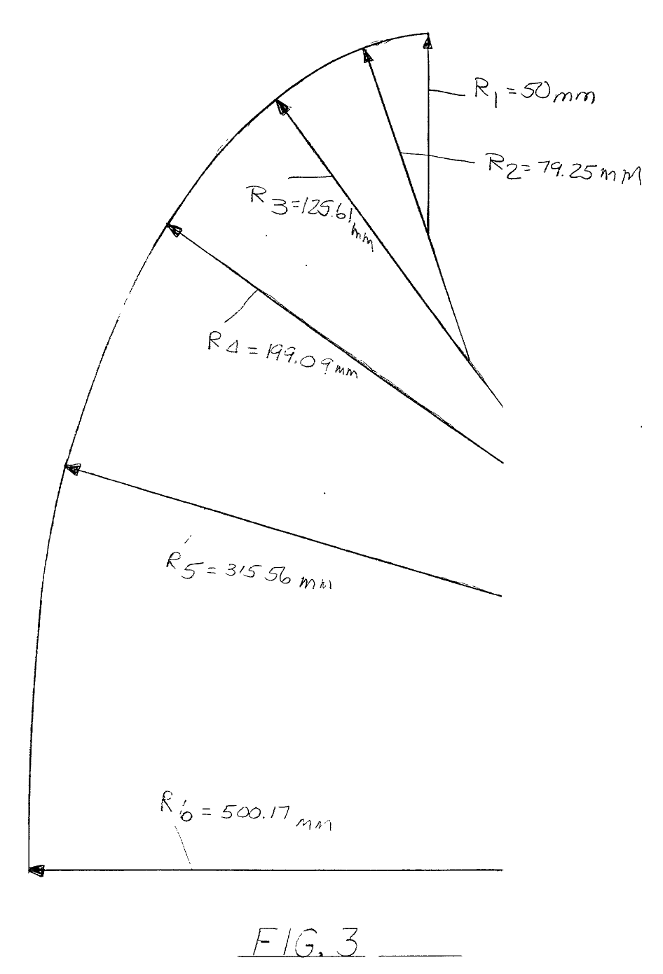

A plot (FIG. 2) of the relationship between circumferential distance and the radius of curvature will allow the maximum radius of curvature causing coating failure to be determined.

From the maximum radius of curvature at the first point of failure, the minimum percent elongation causing failure can be calculated by use of the following formula, where t is the test sample thickness:

$$\text{\% elongation} = \frac{t ( 100 )}{\begin{matrix}2 R + t \\ max\end{matrix}}$$

The following are examples of measurements carried out on hard coated polycarbonate specimens:

Elongation and Radius Calculations Using Continuous Fixture

| | | | | | | | | | | |
|---|---|---|---|---|---|---|---|---|---|---|
| Dimension | Units | AVG | STD | 1 | 2 | 3 | 4 | 5 | 6 | 7 |

Example 1

| | | | | | | | | | | |
|---|---|---|---|---|---|---|---|---|---|---|
| Elongation | Percent | 1.02 | 0.05 | 0.99 | 1.00 | 1.10 | 1.04 | 0.95 | 1.04 | 1.01 |
| Distance From First Line | mms | | | 81.0 | 80.5 | 70.5 | 76.5 | 85.5 | 76.5 | 80.5 |
| Sample test Thickness | mms | | | 4.04 | 4.06 | 4.05 | 4.06 | 4.05 | 4.05 | 4.10 |

Example 2

| | | | | | | | | | | |
|---|---|---|---|---|---|---|---|---|---|---|
| Elongation | Percent | 1.03 | 0.05 | 1.03 | 1.03 | 1.05 | 0.99 | 1.12 | 0.96 | 1.03 |
| Distance From First Line | mms | | | 79.5 | 78.5 | 74.5 | 81.0 | 68.6 | 85.0 | 77.0 |
| Coating Thickness | mms | | | 4.15 | 4.11 | 4.04 | 4.04 | 4.04 | 4.04 | 4.06 |

Example 3

| | | | | | | | | | | |
|---|---|---|---|---|---|---|---|---|---|---|
| Elongation | Percent | 1.43 | 0.06 | 1.42 | 1.37 | 1.41 | 1.41 | 1.55 | 1.40 | 1.47 |
| Distance From First Line | mms | | | 50.5 | 52.8 | 51.0 | 50.9 | 44.9 | 52.0 | 48.5 |
| Coating Thickness | mms | | | 4.17 | 4.14 | 4.17 | 4.17 | 4.23 | 4.20 | 4.20 |

Example 4

| | | | | Coating A | | | Coating B | | |
|---|---|---|---|---|---|---|---|---|---|
| Elongation | Percent | 1.05 | 0.06 | 1.15 | 1.06 | 0.99 | 1.06 | 1.03 | 1.00 |
| Distance From First Line | mms | | | 42.9 | 49.5 | 54.2 | 48.9 | 51.5 | 53.8 |
| Coating Thickness | mms | | | 3.04 | 3.05 | 3.04 | 3.05 | 3.04 | 3.04 |

Example 5

| | | | | | | | | | | |
|---|---|---|---|---|---|---|---|---|---|---|
| Elongation | Percent | 1.46 | 0.16 | 1.59 | 1.18 | 1.50 | 1.36 | 1.49 | 1.42 | 1.65 |
| Distance From First Line | mms | | | 41.5 | 67.5 | 46.0 | 55.0 | 46.0 | 50.8 | 39.1 |
| Coating Thickness | mms | | | 4.13 | 4.22 | 4.16 | 4.22 | 4.13 | 4.19 | 4.15 |

Example 6

| | | | | | | | | | | |
|---|---|---|---|---|---|---|---|---|---|---|
| Elongation | Percent | 1.36 | 0.05 | 1.38 | 1.36 | 1.40 | 1.31 | 1.43 | 1.31 | 1.30 |
| Distance From First Line | mms | | | 52.5 | 53.8 | 52.0 | 56.5 | 51.5 | 56.5 | 57.5 |
| Coating Thickness | mms | | | 4.15 | 4.17 | 4.19 | 4.15 | 4.25 | 4.15 | 4.16 |

The configuration of the surface 16 can take many forms to be advantageously suited to a particular application and can be developed in various ways.

In one example, a 90° arc configuration was selected, with the clamp 18 and minimum radius at the top, to allow maximum leverage in bending the specimen 22 to conform with the surface 16. A 10 inch specimen length and elongation range of 0.4-4% was also selected.

A minimum radius of curvature at 90° is selected to be 50 mm and a maximum radius of curvature of 500 mm is selected for 0°. This range will insure the anticipated elongation of the coating necessary for failure thereof at some point along the surface 16.

In order to develop the intervening curvature, six radii were selected R₁- R₆, as indicated in FIG. 3, with the first, R₁ =50 mm, the last, R₆ =500 mm, the rest extending at 18° intervals from each other, of a correspondingly increasing length.

These intervening radii are determined by selecting a rate of change that will produce a preferred linear relationship between the circumferential distance and the radius R at each point. By an iterative process, a multiplier of 1.585 was determined to be applied to each successive radius in order to yield this linear relationship. An AUTO CAD (trademark) program can then be used to blend the tangencies between each point R₁-R₆ and create the complete form of the surface 16.

The resulting curving contour surface 16 continuously increases in radius from 50 mm to 500 mm in the embodiment shown which gives an elongation range of 0.4-4.0% for the specimen and coating thickness described. The rate of change of the radius of curvature along a given circumferential length determines the resolution of the test, while the length of the surface 16 of course must accommodate the length of the specimen.

As discussed above, the surface 16 can take many different forms depending on the application and the particular design characteristics desired as long as the radii vary from a size where coating failure will not occur to a size where such failure is assured at some point for the specimens and coating thicknesses to be evaluated.

1. A method of evaluating a surface coating on a specimen comprising the steps of:
conforming said specimen to a surface having a radius curvature of progressively varying radius of a predetermined rate of change, the surface having a known predetermined relationship between the distance along said surface and the radii of curvature at each point;
removing said specimen from said surface; and
determining the surface radius of curvature at the point at the maximum radius of curvature whereat coating failure occurs along the length of the specimen.

2. The method according to claim 1 further including the step of calculating the corresponding minimum elongation of said coating producing failure of said coating from the determined radius of curvature at said point.

3. The method according to claim 1 wherein in said step of conforming said specimen with a surface, the radius of said surface continuously varies.

4. The method according to claim 1 wherein the rate of change of said radius of curvature is selected to provide a desired predetermined range of elongations of said coating over the length of said specimen.

5. The method according to claim 1 wherein the rate of change of said radius is selected so as to produce a linear relationship with the distance along said surface.

6. The method according to claim 1 further including the step of clamping one end of said specimen to a fixture having said surface formed thereon at a point adjacent the minimum radius portion of said surface, and thereafter bending said specimen into conformity with said surface.

7. The method according to claim 6 further including the step of marking said specimen at a point whereat said minimum radius curvature and bending begins.

8. The method according to claim 1 wherein said conforming step includes the step of applying a roller against said specimen and advancing the same along said surface.

9. The method according to claim 4 wherein a range of elongations on the order of 0.4-4% is provided by a range of radii extending from approximately 50 mm to 500 mm.

10. The method according to claim 9 wherein a hardcoat applied onto polycarbonate is evaluated by said method.

11. A fixture for imposing a range of elongations on a coating on a flexible strip specimen in order to evaluate the quality of said coating, said fixture comprising:
a base; and,
an upright member fixed to said base formed with a curving perimeter surface configured to allow said specimen to be conformed thereagainst, said surface having a progressively varying radius along the length thereof.

12. The fixture according to claim 1 further including a clamp at the upper portion of said surface enabling clamping of one end of said fixture.

13. The fixture according to claim 12 wherein said surface is at a minimum radius adjacent said clamp.

14. The fixture according to claim 13 wherein said surface has a continuously increasing radius along the length thereof from said clamp.

15. The fixture according to claim 11 wherein said surface radius of curvature varies at a rate establishing a linear relationship between said radius of curvature and the circumferential distance along said surface.
